(19) United States
(12) Patent Application Publication
(10) Pub. No.: US 2026/0362544 A1
(43) Pub. Date: Nov. 12, 2026

(54) COMMUNICATION

(71) Applicant: Beijing Zitiao Network Technology Co., Ltd., Beijing (CN)

(72) Inventors: Guojing Liu, Beijing (CN); Bin Hu, Beijing (CN)

(21) Appl. No.: 19/655,573

(22) Filed: Apr. 22, 2026

(30) Foreign Application Priority Data
May 8, 2025 (CN) 202510593612.4

(51) Int. Cl. H04W 76/28

(52) U.S. Cl. CPC H04W 76/28

(57) ABSTRACT

According to embodiments of the disclosure, a method, an apparatus, a device, a medium, and a program product for communication are provided. The method includes: sending, to a network device, a scheduling request for a target data packet to be sent, the scheduling request including an identification of the target data packet, the identification representing a data packet with a data amount less than a threshold; determining, based on the sending of the identification, a target duration of an inactive timing period for discontinuous reception of the terminal device; and performing data transmission with the network device based on the target duration of the inactive timing period.

### CROSS-REFERENCE

This application claims the benefit of CN Patent Application No. 202510593612.4, filed on May 8, 2025, entitled “Method, Apparatus, Device, Medium, and Program Product for Communication”, which is incorporated herein by reference in its entirety.

### FIELD

Embodiments of the present disclosure generally relate to the field of communications, and in particular, to communication.

### BACKGROUND

In communication technologies, discontinuous reception (DRX) in a radio resource control (RRC) connected state (C-DRX) is an important energy saving mechanism. The mechanism introduces a DRX cycle. In a DRX cycle, a terminal device may turn on a receiving module in a specific time period and turn off the receiving module in the other time period. Therefore, power consumption of the terminal device may be effectively reduced while ensuring that the terminal device maintains a reception capability.

### SUMMARY

In a first aspect of the present disclosure, a method for communication applied on a terminal device is provided. The method includes: sending, to a network device, a scheduling request for a target data packet to be sent, the scheduling request including an identification of the target data packet, the identification representing a data packet with a data amount less than a threshold; determining, based on the sending of the identification, a target duration of an inactive timing period for discontinuous reception of the terminal device; and performing data transmission with the network device based on the target duration of the inactive timing period.

In a second aspect of the present disclosure, a method for communication applied on a network device is provided. The method includes: receiving, from a terminal device, a scheduling request for a target data packet, the scheduling request including an identification of the target data packet, the identification representing a data packet with a data amount less than a threshold; determining, based on the reception of the identification, a target duration of an inactive timing period for discontinuous reception of the terminal device; and performing data transmission with the terminal device based on the target duration of the inactive timing period.

In a third aspect of the present disclosure, an apparatus for communication applied on a terminal device is provided. The apparatus includes: a scheduling request sending module configured to send, to a network device, a scheduling request for a target data packet to be sent, the scheduling request including an identification of the target data packet, the identification representing a data packet with a data amount less than a threshold; a first target duration determination module configured to determine, based on the sending of the identification, a target duration of an inactive timing period for discontinuous reception of the terminal device; and a first data transmission module configured to perform data transmission with the network device based on the target duration of the inactive timing period.

In a fourth aspect of the present disclosure, an apparatus for communication applied on a network device is provided. The apparatus includes: a scheduling request receiving module configured to receive, from a terminal device, a scheduling request for a target data packet, the scheduling request including an identification of the target data packet, the identification representing a data packet with a data amount less than a threshold; a second target duration determination module configured to determine, based on the reception of the identification, a target duration of an inactive timing period for discontinuous reception of the terminal device; and a second data transmission module configured to perform data transmission with the terminal device based on the target duration of the inactive timing period.

In a fifth aspect of the present disclosure, an electronic device is provided. The device includes at least one processor; and at least one memory, the at least one memory being coupled to the at least one processor and storing instructions for execution by the at least one processor, the instructions, when executed by the at least one processor, causing the device to perform the method of the first aspect or the second aspect.

In a sixth aspect of the present disclosure, a computer-readable storage medium is provided. The computer-readable storage medium has computer-executable instructions stored thereon, the computer-executable instructions being executable by a processor to implement the method of the first aspect or the second aspect.

In a seventh aspect of the present disclosure, a computer program product is provided. The computer program product is tangibly stored in a computer storage medium and includes computer-executable instructions, the computer-executable instructions, when executed by a device, causing the device to perform the method of the first aspect or the second aspect of the present disclosure.

It should be understood that the content described in this section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages, and aspects of the embodiments of the present disclosure become more apparent with reference to the following detailed description and in conjunction with the drawings. In the drawings, the same or similar reference numerals denote the same or similar elements, where:

FIG. 1 illustrates a schematic diagram of an example environment in which the embodiments according to the present disclosure can be implemented;

FIG. 2 illustrates a schematic diagram of a signaling procedure for DRX according to some embodiments of the present disclosure;

FIG. 3 illustrates a flowchart of a procedure for communication according to some embodiments of the present disclosure;

FIG. 4 illustrates a flowchart of a procedure for communication according to some embodiments of the present disclosure;

FIG. 5 illustrates a schematic block diagram of an apparatus for communication according to some embodiments of the present disclosure;

FIG. 6 illustrates a schematic block diagram of an apparatus for communication according to some embodiments of the present disclosure; and

FIG. 7 illustrates a block diagram of an electronic device capable of implementing a plurality of embodiments of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms, and should not be construed as limited to the embodiments set forth herein. Instead, these embodiments are provided for a more thorough and complete understanding of the present disclosure. It should be understood that the drawings and embodiments of the present disclosure are only for illustrative purposes, and are not intended to limit the scope of protection of the present disclosure.

In the description of the embodiments of the present disclosure, the term “include/comprise” and similar terms thereof should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. The following may also include other explicit and implicit definitions.

Herein, unless otherwise explicitly specified, performing a step “in response to A” does not mean that the step is performed immediately after “A”, and may include one or more intermediate steps.

It may be understood that the data involved in the technical solution (including but not limited to the data itself, acquisition or use of the data) should comply with requirements of corresponding laws, regulations, and related provisions.

It may be understood that before the use of the technical solution disclosed in the embodiments of the present disclosure, the user should be informed of the type, range of use, use scenarios, etc., of personal information involved in the present disclosure in an appropriate manner and the authorization of the user should be obtained according to relevant laws and regulations.

For example, in response to reception of an active request from a user, prompt information is sent to the user to clearly inform the user that the requested operation will require access to and use of the user's personal information, so that the user may independently choose, based on the prompt information, whether to provide the personal information to software or hardware, such as an electronic device, an application, a server, or a storage medium, that performs the operations of the technical solution of the present disclosure.

As an optional but non-restrictive implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure. Other manners that satisfy the relevant laws and regulations may also be applied in the implementations of the present disclosure.

As used herein, a term “model” may learn a correlation between corresponding inputs and outputs from training data, so that a corresponding output may be generated for a given input after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, a “model” may also be referred to as a “machine learning model”, a “learning model”, a “machine learning network”, or a “learning network”, which terms are used interchangeably herein.

As mentioned above, discontinuous reception in the RRC connected state is an important energy saving mechanism. The mechanism introduces the DRX cycle. In a DRX cycle, the terminal device may turn on the receiving module in a specific time period, and turn off the receiving module in the other time period. Therefore, the power consumption of the terminal device may be effectively reduced while ensuring that the terminal device maintains the reception capability.

The DRX cycle is divided into a long DRX cycle (indicated by an information element (IE) longDRX cycle) and a short DRX cycle (indicated by an IE shortDRX cycle). When the terminal device is configured with the long DRX cycle, it is woken up at a long time interval. When the network traffic is low, the use of the long DRX cycle may reduce the power consumption of the terminal device. When the terminal device is configured with the short DRX cycle, it is woken up at a short time interval. When the network traffic is high, the use of the short DRX cycle may enable the terminal device to timely check whether there is a need for data transmission.

In a DRX cycle, the turning on and off of the receiving module is mainly implemented through cooperation between the activation of a duration timer (indicated by an IE onDurationTimer) and the activation of an inactivity timer (indicated by an IE inactivityTimer). The onDurationTimer is a timer that is started at the beginning of each DRX cycle. When the timer is running, the terminal device is in an active state, and needs to continuously monitor a downlink control channel to receive possible scheduling information. During the timing period of the onDurationTimer, the terminal device keeps the receiving module on. If no scheduling information is received in this time period, the terminal device enters a sleep state according to a subsequent rule. The inactivityTimer is a timer that starts when the terminal device receives data or scheduling information. If the terminal device does not receive new data or scheduling information during the running of the timer, the terminal device turns off the receiving module and enters the sleep state after the timer expires.

The network device configures a long DRX cycle or a short DRX cycle, the onDurationTimer, and the inactivityTimer for the terminal device based on factors such as a specific service requirement, network load, and a capability of the terminal device, to implement a balance between energy saving and data transmission.

Generally, if the terminal device receives data during the timing period of the onDurationTimer, a configured inactivityTimer is started, and the terminal device continues to remain active during the timing period of the inactivityTimer. For example, a duration of the inactivityTimer may be 80 ms. However, if a data amount of a target data packet that the terminal device needs to send is small (for example, 5 KB), the terminal device may complete data sending in a short time (for example, 1 ms). In this case, the terminal device still needs to wait until the timing of the inactivityTimer ends before entering the sleep state, which leads to unnecessary power consumption.

In view of this, the embodiments of the present disclosure provide a solution for communication. According to the solution, a terminal device sends, to a network device, a scheduling request for a target data packet to be sent. The scheduling request includes an identification of the target data packet. The identification represents a data packet with a data amount less than a threshold. Based on the sending of the identification, the terminal device determines a target duration of an inactive timing period for discontinuous reception. Based on the target duration of the inactive timing period (for example, an inactivity timer), the terminal device performs data transmission with the network device.

In the embodiments of the present disclosure, the identification representing the data packet (also referred to as a small data packet) with the data amount less than the threshold is introduced. The terminal device sends, to the network device, the scheduling request including the identification, to enable the network device to learn that the data amount of the target data packet to be sent by the terminal device is less than the threshold. Therefore, the terminal device and the network device may determine an appropriate target duration of the inactive timing period. Based on the target duration, the data transmission between the terminal device and the network device may be performed. In this manner, when the data amount of the data packet to be sent by the terminal device is small, the target duration of the inactive timing period may be adjusted to a small value, thereby avoiding waste of power consumption of the terminal device.

Various example implementations of the solution are described in detail below with further reference to the drawings.

### Example Environment

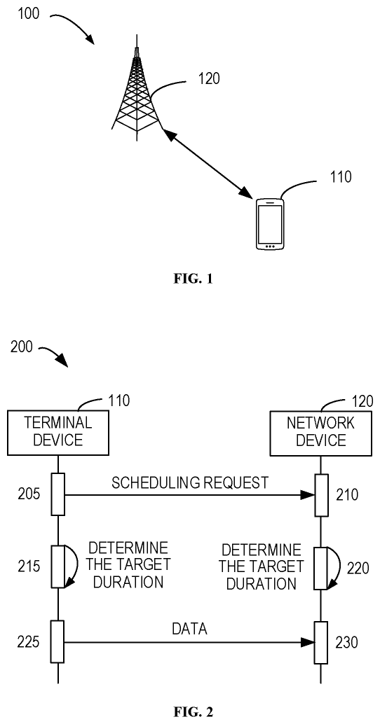

FIG. 1 illustrates a schematic diagram of an example environment 100 in which the embodiments of the present disclosure may be implemented. In the environment 100 shown in FIG. 1, a plurality of communication devices, including a terminal device 110 and a network device 120, may communicate with each other. In some embodiments, the terminal device 110 may be user equipment (UE), and the network device 120 may be a base station (BS) that provides a service for the user equipment. The network device 120 operates in a radio access network (RAN), and therefore may also be referred to as a RAN network device.

It should be understood that the number of devices and the connection manner shown in FIG. 1 are only for illustrative purposes, and do not constitute any limitation. The environment 100 may include any appropriate number of devices configured to implement the embodiments of the present disclosure. It should be noted that although the network device 120 is illustrated as a network device, it may be another device other than the network device. Although the terminal device 110 is illustrated as a terminal device, it may be another device other than the terminal device.

For ease of illustration, some embodiments are described below in the case where the terminal device 110 operates as a UE and the network device 120 operates as a base station. However, in some embodiments, the operations related to the terminal device may be implemented on the network device or another device, and the operations related to the network device may be implemented on the terminal device or another device.

In some embodiments, a communication direction from the network device 120 to the terminal device 110 is referred to as a downlink (DL), and a communication direction from the terminal device 110 to the network device 120 is referred to as an uplink (UL). In the downlink, the network device 120 is a transmitting (TX) device (or a transmitter), and the terminal device 110 is a receiving (RX) device (or a receiver). In the uplink, the terminal device 110 is a transmitting (TX) device (or a transmitter), and the network device 120 is a receiving (RX) device (or a receiver).

The communication in the environment 100 may be implemented according to any appropriate communication protocol, including but not limited to a cellular communication protocol such as first generation (1G), second generation (2G), third generation (3G), fourth generation (4G), fifth generation (5G), and sixth generation (6G), a wireless local area network communication protocol such as Institute of Electrical and Electronics Engineers (IEEE) 802.11, and/or any other protocol currently known or to be developed in the future. Furthermore, the communication may use any appropriate wireless communication technology, including but not limited to: code division multiple access (CDMA), frequency division multiple access (FDMA), time division multiple access (TDMA), frequency division duplex (FDD), time division duplex (TDD), multiple input multiple output (MIMO), orthogonal frequency division multiplexing (OFDM), discrete Fourier transform spread orthogonal frequency division multiplexing (DFT-s-OFDM), and/or any other technology currently known or to be developed in the future.

Some embodiments of the present disclosure are described below with continued reference to the drawings.

### Example Interaction

FIG. 2 illustrates a schematic diagram of a signaling procedure 200 for communication according to some embodiments of the present disclosure. The signaling procedure 200 involves the terminal device 110 and the network device 120. In some embodiments, the terminal device 110 may be a UE, and the network device 120 may be a base station. For ease of discussion, some embodiments of the signaling procedure 200 are described with reference to FIG. 1.

When the terminal device 110 has a data sending requirement, the terminal device 110 sends a scheduling request to the network device 120. The network device 120 may configure resources and parameters related to C-DRX for the terminal device 110 based on the received scheduling request. If a data amount of a target data packet to be sent is less than a threshold, the terminal device 110 introduces an identification (for example, a flag) to identify the target data packet. When the received scheduling request includes the identification, the network device 120 may adjust the parameters related to the C-DRX accordingly.

As shown in FIG. 2, the terminal device 110 sends (205), to the network device 120, a scheduling request for a target data packet to be sent. The scheduling request sent by the terminal device 110 includes an identification of the target data packet. The identification represents that a data amount of the target data packet is less than a threshold. In the embodiments of the present disclosure, a data packet with a data amount less than the threshold is also referred to as a “small data packet”. The flag identifying the small data packet may be sent at a medium access control (MAC) layer. The threshold may be different depending on a specific application scenario. By way of example only, the threshold may be 2k bytes (2 kB). That is, if the data amount of the data packet to be sent is less than 2 kB, the terminal device 110 may identify the data packet as a small data packet.

In some embodiments, the identification may further indicate a data amount range of the target data packet. In an example, the identification may be a two-bit flag. The flag may represent four different combinations: 00, 01, 10, and 11. The four combinations may be used to indicate different data amount ranges of the target data packet. For example, 00 may represent that the data amount range of the target data packet is 0 to 5 KB, 01 may represent that the data amount range of the target data packet is 5 to 10 KB, 10 may represent that the data amount range of the target data packet is 10 to 15 KB, and 11 may represent that the data amount range of the target data packet is 15 to 20 KB.

The network device 120 receives (210) the scheduling request from the terminal device 110. Based on the identification in the scheduling request, the network device 120 determines (220) a target duration of an inactive timing period for the C-DRX of the terminal device 110. The inactive timing period may be set as, for example, the inactivityTimer. The following describes the procedure of determining the target duration of the inactive timing period.

In some embodiments, the network device 120 may determine a configured duration T of the inactive timing period. The configured duration may be configured by the network device 120 based on a communication protocol, a communication requirement, etc. For example, the configured duration may be 80 ms. Based on the received identification, the network device 120 may determine an update coefficient n for the inactive timing period. Based on the configured duration T and the update coefficient n, the network device 120 may determine the target duration t of the inactive timing period. For example, t=T/n. When the update coefficient n is 4, the target duration is 20 ms. As described above, when the target data packet is a “small data packet”, the terminal device 110 may complete sending of the target data packet in 1 ms. Therefore, the reduction of the inactive timing period from 80 ms to 20 ms may reduce unnecessary power consumption of the terminal device 110. Certainly, the durations in the above examples are only illustrative, and may be adjusted based on an actual application.

With continued reference to FIG. 2, based on the sending of the identification, the terminal device 110 determines (215) the target duration of the inactive timing period. In some embodiments, the terminal device 110 may determine the target duration in the same manner based on a common understanding with the network device 120. Specifically, the terminal device 110 may receive configuration information for the C-DRX from the network device 120. The configuration information may indicate the configured duration T, for example, 80 ms, of the inactive timing period. Based on the identification representing that the data amount of the target data packet is less than the threshold, the terminal device 110 may determine the update coefficient n, for example, n=4, for the inactive timing period. Based on the configured duration and the update coefficient, the terminal device 110 may determine the target duration t, for example, 20 ms, of the inactive timing period.

Alternatively, or additionally, in some embodiments, the terminal device 110 may directly receive the update coefficient for the inactive timing period from the network device 120. Specifically, the terminal device 110 may receive the configuration information for the C-DRX from the network device 120. The configuration information may indicate the configured duration of the inactive timing period. When the terminal device 110 needs to send a target data packet with a data amount less than the threshold, the terminal device 110 may send, to the network device 120, the identification identifying the data packet. Based on the reception of the identification, the network device 120 may determine the update coefficient of the inactive timing period, and send the update coefficient to the terminal device 110. The terminal device 110 may determine the target duration of the inactive timing period based on the configured duration of the inactive timing period and the received update coefficient.

Alternatively, or additionally, in some embodiments, the terminal device 110 may directly receive the target duration of the inactive timing period from the network device 120. Specifically, when the terminal device 110 needs to send a target data packet with a data amount less than the threshold, the terminal device 110 may send, to the network device 120, the identification identifying the data packet. Based on the reception of the identification, the network device 120 may determine the target duration of the inactive timing period, and send indication information of the target duration to the terminal device 110. The terminal device 110 may determine the target duration of the inactive timing period based on the received indication information.

In some embodiments, the update coefficient of the inactive timing period may be determined based on a data amount range of the target data packet. As described above, the identification may indicate the data amount range of the target data packet, for example, 00 indicates that the data amount range is 0 to 5 KB, 01 indicates that the data amount range is 5 to 10 KB, etc. A smaller data amount range of the target data packet leads to a larger update coefficient, and thus a smaller updated target duration. For example, the configured duration of the inactive timing period is 80 ms. When the data amount of the target data packet is 0 to 5 KB, the update coefficient is 4, and the target duration is 80/4=20 ms. When the data amount of the target data packet is 5 to 10 KB, the update coefficient is 2, and the target duration is 80/2=40 ms. In this manner, a smaller “small data packet” leads to a shorter target duration of the inactive timing period, thereby reducing the power consumption of the terminal device 110 more flexibly.

In some embodiments, the update coefficient of the inactive timing period is determined based on a slot interval between at least two data transmissions between the terminal device 110 and the network device 120. For example, the slot interval may include a second slot interval K2 between a moment when the terminal device 110 receives control information for scheduling the target data packet from the network device 120 and a moment when the terminal device 110 sends the target data packet to the network device 120. The target duration obtained based on the configured duration and the update coefficient needs to be greater than the second slot interval K2, to avoid a case where the timing of the inactive timing period ends before the target data packet is sent.

Alternatively, or additionally, the slot interval may include a first slot interval K1 between a moment when the terminal device 110 receives data from the network device 120 and a moment when the terminal device 110 sends first acknowledgement (ACK) information for the received data to the network device 120. Alternatively, or additionally, the slot interval may include a third slot interval K3 between a moment when the terminal device 110 receives second acknowledgement information for the sent data from the network device 120 and a moment when the terminal device 110 retransmits the data to the network device 120. Certainly, the slot interval may further include other slot intervals other than the foregoing K1, K2, and K3. In this manner, the update coefficient of the inactive timing period is determined by considering the slot interval between the at least two data transmissions between the terminal device 110 and the network device 120, so that data transmission conflicts may be avoided, and a latency may also be reduced.

In some embodiments, the terminal device 110 may send data amount information to the network device 120. The data amount information indicates a data amount of the target data packet to be sent. For example, the data amount information may be sent to the network device 120 through a buffer status report (BSR). The network device 120 may learn, based on the BSR, the data amount of the target data packet to be transmitted in a buffer of the terminal device 110, to reasonably allocate uplink resources. The network device 120 sends resource allocation information to the terminal device 110. The information indicates resources allocated for the sending of the target data packet, for example, an uplink grant (UL grant). The UL grant may include, for example, an allocation of resource blocks (RBs). The resources allocated by the network device 120 to the terminal device 110 may affect the time required for the terminal device 110 to send the target data packet. Generally, more resources allocated for the sending of the target data packet lead to a shorter time required for the terminal device 110 to send the target data packet. Therefore, the update coefficient of the inactive timing period may be determined based on the data amount of the target data packet and an amount of the allocated resources. For example, more resources allocated by the network device 120 to the target data packet containing a specific data amount lead to a larger update coefficient, thereby shortening the duration of the inactive timing period to a larger extent. In this manner, more resources allocated to the “small data packet” lead to a shorter target duration of the inactive timing period, thereby reducing the power consumption of the terminal device 110 more flexibly.

It may be understood that the target duration of the inactive timing period may alternatively be determined based on a plurality of factors mentioned in the above embodiments.

With continued reference to FIG. 2, after determining the target duration of the inactive timing period, the terminal device 110 sends (225) the target data packet to the network device 120. The network device 120 receives (230) the target data packet from the terminal device 110. That is, the terminal device 110 and the network device 120 perform data transmission during the timing period of the inactive timing period.

Through the above solution, the terminal device and the network device may flexibly determine the target duration of the inactive timing period for C-DRX based on the identification representing the data packet with the data amount less than the threshold, so that the power consumption of the terminal device may be reduced while ensuring normal data transmission.

### Example Process

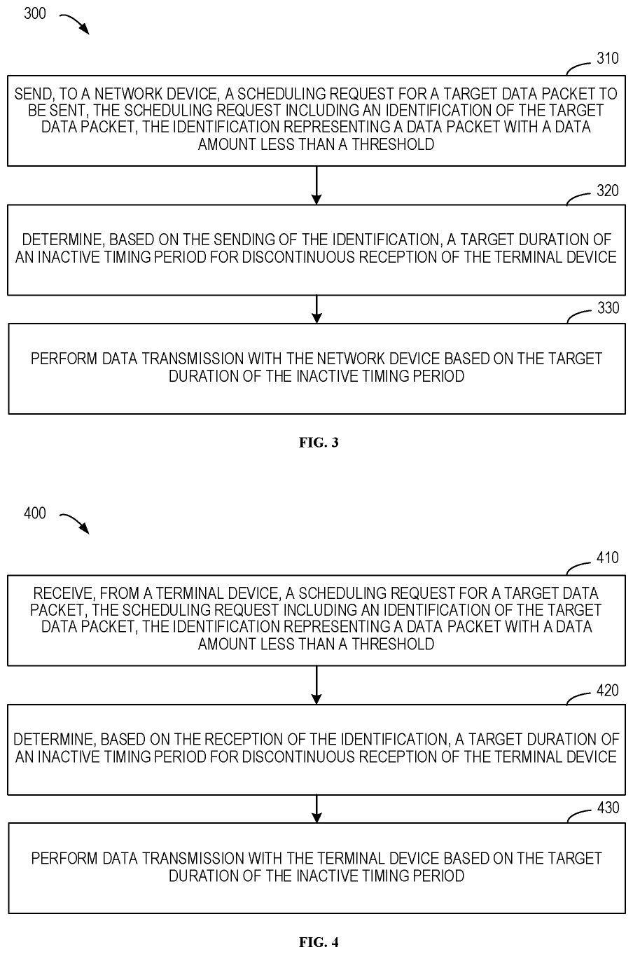

FIG. 3 illustrates a flowchart of a process 300 for communication according to some embodiments of the present disclosure. The process 300 may be implemented at the terminal device 110. The process 300 is described below with reference to FIG. 1.

At block 310, the terminal device 110 sends, to a network device, a scheduling request for a target data packet to be sent, the scheduling request including an identification of the target data packet, the identification representing a data packet with a data amount less than a threshold.

At block 320, the terminal device 110 determines, based on the sending of the identification, a target duration of an inactive timing period for discontinuous reception of the terminal device.

At block 330, the terminal device 110 performs data transmission with the network device based on the target duration of the inactive timing period.

In some embodiments, determining the target duration of the inactive timing period may include: receiving, from the network device, configuration information for discontinuous reception, the configuration information indicating a configured duration of the inactive timing period; determining, based on the identification, an update coefficient for the inactive timing period; and determining the target duration based on the configured duration and the update coefficient.

In some embodiments, determining the target duration of the inactive timing period may include: receiving, from the network device, indication information of the target duration in response to the sending of the identification, the target duration being determined by the network device based on a configured duration of the inactive timing period and an update coefficient for the inactive timing period.

In some embodiments, determining the target duration of the inactive timing period may include: receiving, from the network device, configuration information for discontinuous reception, the configuration information indicating a configured duration of the inactive timing period; receiving, from the network device, indication information about an update coefficient in response to the sending of the identification, the update coefficient being configured to update a duration of the inactive timing period; and determining the target duration based on the configured duration and the update coefficient.

In some embodiments, the identification may further indicate a data amount range of the target data packet, and the update coefficient is determined based on the data amount range of the target data packet.

In some embodiments, the update coefficient is determined based on a slot interval between at least two data transmissions between the network device and the terminal device.

In some embodiments, the slot interval may include at least one of the following: a first slot interval between the terminal device receiving data from the network device and the terminal device sending first acknowledgment information for the received data to the network device, a second slot interval between the terminal device receiving control information scheduling the target data packet from the network device and the terminal device sending the target data packet to the network device, or a third slot interval between the terminal device receiving second acknowledgment information for sent data from the network device and the terminal device retransmitting the data to the network device.

In some embodiments, the process 300 may further include: sending, by the terminal device 110, data amount information to the network device 120, the data amount information indicating a data amount of the target data packet to be sent; and receiving, from the network device 120, resource allocation information indicating resources allocated for the sending of the target data packet; and the update coefficient is determined based on the data amount of the target data packet and an amount of the resources.

FIG. 4 illustrates a flowchart of a process 400 for communication according to some embodiments of the present disclosure. The process 400 may be implemented at the network device 120. The process 400 is described below with reference to FIG. 1.

At block 410, the network device 120 receives, from a terminal device, a scheduling request for a target data packet, the scheduling request including an identification of the target data packet, the identification representing a data packet with a data amount less than a threshold.

At block 420, the network device 120 determines, based on the reception of the identification, a target duration of an inactive timing period for discontinuous reception of the terminal device.

At block 430, the network device 120 performs data transmission with the terminal device based on the target duration of the inactive timing period.

In some embodiments, determining the target duration of the inactive timing period may include: determining a configured duration of the inactive timing period; determining, based on the identification, an update coefficient for the inactive timing period; and determining the target duration based on the configured duration and the update coefficient.

In some embodiments, the process 400 may further include: sending, to the terminal device, the update coefficient for the inactive timing period in response to the reception of the identification.

In some embodiments, the process 400 may further include: sending the target duration to the terminal device in response to the reception of the identification.

In some embodiments, the identification may further indicate a data amount range of the target data packet, and the update coefficient is determined based on the data amount range of the target data packet.

In some embodiments, the update coefficient is determined based on a slot interval between at least two data transmissions between the network device and the terminal device.

In some embodiments, the slot interval may include at least one of the following: a first slot interval between the terminal device receiving data from the network device and the terminal device sending first acknowledgment information for the received data to the network device, a second slot interval between the terminal device receiving control information scheduling the target data packet from the network device and the terminal device sending the target data packet to the network device, or a third slot interval between the terminal device receiving second acknowledgment information for sent data from the network device and the terminal device retransmitting the data to the network device.

In some embodiments, the process 400 may further include: receiving, by the network device 120, data amount information from the terminal device 110, the data amount information indicating a data amount of the target data packet to be sent; determining resources allocated for the sending of the target data packet; and sending resource allocation information to the terminal device 110, the resource allocation information indicating the resources allocated for the sending of the target data packet; and the update coefficient is determined based on the data amount of the target data packet and an amount of the resources.

### Example Apparatus and Device

FIG. 5 illustrates a schematic structural block diagram of an apparatus 500 for communication according to some embodiments of the present disclosure. The apparatus 500 may be implemented as or included in the terminal device 110. Each module/component in the apparatus 500 may be implemented by hardware, software, firmware, or any combination thereof.

As shown in the figure, the apparatus 500 includes a scheduling request sending module 510 configured to send, to a network device, a scheduling request for a target data packet to be sent, the scheduling request including an identification of the target data packet, the identification representing a data packet with a data amount less than a threshold; a first target duration determination module 520 configured to determine, based on sending of the identification, a target duration of an inactive timing period for discontinuous reception of the terminal device; and a first data transmission module 530 configured to perform data transmission with the network device based on the target duration of the inactive timing period.

In some embodiments, the first target duration determination module 520 may be further configured to: receive, from the network device, configuration information for discontinuous reception, the configuration information indicating a configured duration of the inactive timing period; determine, based on the identification, an update coefficient for the inactive timing period; and determine the target duration based on the configured duration and the update coefficient.

In some embodiments, the first target duration determination module 520 may be further configured to: receive, from the network device, indication information about the target duration in response to the sending of the identification, the target duration being determined by the network device based on a configured duration of the inactive timing period and an update coefficient for the inactive timing period.

In some embodiments, the first target duration determination module 520 may be further configured to: receive, from the network device, configuration information for discontinuous reception, the configuration information indicating a configured duration of the inactive timing period; receive, from the network device, indication information about an update coefficient in response to the sending of the identification, the update coefficient being configured to update a duration of the inactive timing period; and determine the target duration based on the configured duration and the update coefficient.

In some embodiments, the identification may further indicate a data amount range of the target data packet, and the update coefficient is determined based on the data amount range of the target data packet.

In some embodiments, the update coefficient is determined based on a slot interval between at least two data transmissions between the network device and the terminal device.

In some embodiments, the slot interval may include at least one of the following: a first slot interval between the terminal device receiving data from the network device and the terminal device sending first acknowledgment information for the received data to the network device, a second slot interval between the terminal device receiving control information scheduling the target data packet from the network device and the terminal device sending the target data packet to the network device, or a third slot interval between the terminal device receiving second acknowledgment information for sent data from the network device and the terminal device retransmitting the data to the network device.

In some embodiments, the first target duration determination module 520 may be further configured to: send, by the terminal device 110, data amount information to the network device 120, the data amount information indicating a data amount of the target data packet to be sent; and receive, from the network device 120, resource allocation information indicating resources allocated for the sending of the target data packet; and the update coefficient may be determined based on the data amount of the target data packet and an amount of the resources.

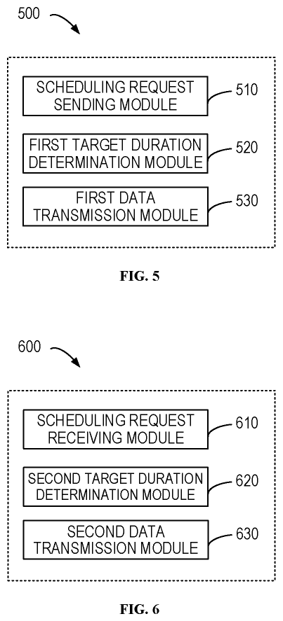

FIG. 6 illustrates a schematic structural block diagram of an apparatus 600 for communication according to some embodiments of the present disclosure. The apparatus 600 may be implemented as or included in the network device 120. Each module/component in the apparatus 600 may be implemented by hardware, software, firmware, or any combination thereof.

As shown in the figure, the apparatus 600 includes a scheduling request receiving module 610 configured to receive, from a terminal device, a scheduling request for a target data packet, the scheduling request including an identification of the target data packet, the identification representing a data packet with a data amount less than a threshold; a second target duration determination module 620 configured to determine, based on the reception of the identification, a target duration of an inactive timing period for discontinuous reception of the terminal device; and a second data transmission module 630 configured to perform data transmission with the terminal device based on the target duration of the inactive timing period.

In some embodiments, the second target duration determination module 620 may be further configured to: determine a configured duration of the inactive timing period; determine, based on the identification, an update coefficient for the inactive timing period; and determine the target duration based on the configured duration and the update coefficient.

In some embodiments, the apparatus 600 may further include: an update coefficient sending module configured to send, to the terminal device, the update coefficient for the inactive timing period in response to the reception of the identification.

In some embodiments, the apparatus 600 may further include: a target duration sending module configured to send the target duration to the terminal device in response to the reception of the identification.

In some embodiments, the identification may further indicate a data amount range of the target data packet, and the update coefficient may be determined based on the data amount range of the target data packet.

In some embodiments, the update coefficient may be determined based on a slot interval between at least two data transmissions between the network device and the terminal device.

In some embodiments, the slot interval may include at least one of the following: a first slot interval between the terminal device receiving data from the network device and the terminal device sending first acknowledgment information for the received data to the network device, a second slot interval between the terminal device receiving control information scheduling the target data packet from the network device and the terminal device sending the target data packet to the network device, or a third slot interval between the terminal device receiving second acknowledgment information for sent data from the network device and the terminal device retransmitting the data to the network device.

In some embodiments, the apparatus 600 may further include: a data amount information receiving module configured to receive data amount information from the terminal device 110, the data amount information indicating a data amount of the target data packet to be sent; a resource allocation module configured to determine resources allocated for the sending of the target data packet; and an allocation information sending module configured to send resource allocation information to the terminal device 110, the resource allocation information indicating the resources allocated for the sending of the target data packet; and the update coefficient may be determined based on the data amount of the target data packet and an amount of the resources.

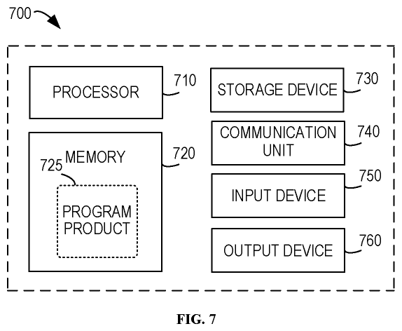

FIG. 7 illustrates a block diagram of an electronic device 700 in which one or more embodiments of the present disclosure may be implemented. It should be understood that the electronic device 700 shown in FIG. 7 is merely illustrative, and should not constitute any limitation on the functions and scope of the embodiments described herein. The electronic device 700 shown in FIG. 7 may include or be implemented as the terminal device 110 or the network device 120 shown in FIG. 1.

As shown in FIG. 7, the electronic device 700 is in a form of a general-purpose electronic device. Components of the electronic device 700 may include, but are not limited to, at least one processor 710 or processing unit, a memory 720, a storage device 730, one or more communication units 740, one or more input devices 750, and one or more output devices 760. The processor 710 may be an actual or virtual processor, and may perform various processing based on a program stored in the memory 720. In a multi-processor system, a plurality of processors execute computer-executable instructions in parallel, to improve a parallel processing capability of the electronic device 700.

The electronic device 700 generally includes a plurality of computer storage media. Such media may be any available media accessible by the electronic device 700, including, but not limited to, volatile and non-volatile media, and removable and non-removable media. The memory 720 may be a volatile memory (for example, a register, a cache, or a random access memory (RAM)), a non-volatile memory (for example, a read-only memory (ROM), an electrically erasable programmable read-only memory (EEPROM), or a flash memory), or any combination thereof. The storage device 730 may be a removable or non-removable medium, and may include a machine-readable medium, for example, a flash drive, a disk, or any other medium, which may be used for storing information and/or data and may be accessed in the electronic device 700.

The electronic device 700 may further include other removable/non-removable, volatile/non-volatile storage media. Although not shown in FIG. 7, a disk driver for reading from or writing into removable and non-volatile disks (for example, a “floppy disk”), and an optical disk driver for reading from or writing into removable and non-volatile optical disks may be provided. In these cases, each driver may be connected to a bus (not shown) through one or more data medium interfaces. The memory 720 may include a computer program product 725 having one or more program modules configured to perform various methods or acts of the various embodiments of the present disclosure.

The communication unit 740 implements communication with another electronic device through a communication medium. Additionally, the functions of the components of the electronic device 700 may be implemented by a single computing cluster or a plurality of computing machines, which may communicate through a communication connection. Therefore, the electronic device 700 may perform operations in a networked environment through a logical connection with one or more other servers, a network personal computer (PC), or another network node.

The input device 750 may be one or more input devices, for example, a mouse, a keyboard, or a tracking ball. The output device 760 may be one or more output devices, for example, a display, a speaker, or a printer. The electronic device 700 may further communicate with one or more external devices (not shown) through the communication unit 740 as needed, the external devices being, for example, the storage device or the display device, communicate with one or more devices that enable a user to interact with the electronic device 700, or communicate with any device (for example, a network card or a modem) that enables the electronic device 700 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, where the computer-executable instructions are executed by a processor to implement the method described above.

Various aspects of the present disclosure are described herein with reference to flowcharts and/or block diagrams of a method, an apparatus, a device, and a computer program product implemented according to the present disclosure. It should be understood that each block in the flowchart and/or the block diagram, and a combination of the blocks in the flowchart and/or the block diagram may be implemented by computer-readable program instructions.

These computer-readable program instructions may be provided to a processor of a general-purpose computer, a special-purpose computer, or another programmable data processing apparatus, to produce a machine, so that when the instructions are executed by the processor of the computer or another programmable data processing apparatus, an apparatus that implements a specific function/act in one or more blocks in the flowchart and/or the block diagram is produced. These computer-readable program instructions may also be stored in a computer-readable storage medium, and the instructions cause the computer, the programmable data processing apparatus, and/or another device to work in a specific manner, so that the computer-readable medium having the instructions stored thereon includes a manufactured product including instructions for implementing various aspects of the specific function/act in one or more blocks in the flowchart and/or the block diagram.

The computer-readable program instructions may be loaded onto a computer, another programmable data processing apparatus, or another device, to cause a series of operation steps to be performed on the computer, another programmable data processing apparatus, or another device, to produce a computer-implemented process, so that the instructions executed on the computer, another programmable data processing apparatus, or another device implement the specific function/act in one or more blocks in the flowchart and/or the block diagram.

The flowchart and block diagram in the drawings show the possibly implemented architectures, functions, and operations of the system, the method, and the computer program product according to a plurality of implementations of the present disclosure. In this regard, each block in the flowchart or the block diagram may represent a module, a program segment, or a part of an instruction, and the module, the program segment, or the part of the instruction includes one or more executable instructions for implementing a specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a special-purpose hardware-based system that executes a specific function or act, or may be implemented by a combination of special-purpose hardware and computer instructions.

The implementations of the present disclosure have been described above. The foregoing description is illustrative, non-exhaustive, and not intended to limit the disclosed implementations. Without departing from the scope and spirit of the illustrated implementations, many modifications and variations will be apparent to those of ordinary skill in the art. The selection of the terms used herein is intended to best explain the principles of the implementations, the practical applications, or the improvements to the technologies in the market, or to enable other people of ordinary skill in the art to understand the implementations disclosed herein.

1. A method for communication, applied on a terminal device, comprising:
sending, to a network device, a scheduling request for a data packet to be sent, the scheduling request comprising an identification of the data packet, the identification representing a data packet with a data amount less than a threshold;
determining, based on the sending of the identification, a first duration of an inactive timing period for discontinuous reception of the terminal device; and
performing data transmission with the network device based on the first duration of the inactive timing period.

2. The method of claim 1, wherein determining the first duration of the inactive timing period comprises:
receiving, from the network device, configuration information for the discontinuous reception, the configuration information indicating a configured duration of the inactive timing period;
determining, based on the identification, an update coefficient for the inactive timing period; and
determining the first duration based on the configured duration and the update coefficient.

3. The method of claim 1, wherein determining the first duration of the inactive timing period comprises:
receiving, from the network device, indication information about the first duration in response to the sending of the identification, the first duration being determined by the network device based on a configured duration of the inactive timing period and an update coefficient for the inactive timing period.

4. The method of claim 1, wherein determining the first duration of the inactive timing period comprises:
receiving, from the network device, configuration information for the discontinuous reception, the configuration information indicating a configured duration of the inactive timing period;
receiving, from the network device, indication information about an update coefficient in response to the sending of the identification, the update coefficient being configured to update a duration of the inactive timing period; and
determining the first duration based on the configured duration and the update coefficient.

5. The method of claim 2, wherein the identification further indicates a data amount range of the data packet, and the update coefficient is determined based on the data amount range of the data packet.

6. The method of claim 2, wherein the update coefficient is determined based on a slot interval between at least two data transmissions between the network device and the terminal device.

7. The method of claim 6, wherein the slot interval comprises at least one of the following:
a first slot interval between the terminal device receiving data from the network device and the terminal device sending first acknowledgment information for the received data to the network device,
a second slot interval between the terminal device receiving control information scheduling the data packet from the network device and the terminal device sending the data packet to the network device, or
a third slot interval between the terminal device receiving second acknowledgment information for sent data from the network device and the terminal device retransmitting the data to the network device.

8. The method of claim 2, further comprising:
sending data amount information to the network device, the data amount information indicating a data amount of the data packet to be sent; and
receiving resource allocation information from the network device, the resource allocation information indicating resources allocated for the sending of the data packet;
and wherein the update coefficient is determined based on the data amount of the data packet and an amount of the resources.

9. A method for communication, applied on a network device, comprising:
receiving, from a terminal device, a scheduling request for a data packet, the scheduling request comprising an identification of the data packet, the identification representing a data packet with a data amount less than a threshold;
determining, based on the reception of the identification, a first duration of an inactive timing period for discontinuous reception of the terminal device; and
performing data transmission with the terminal device based on the first duration of the inactive timing period.

10. The method of claim 9, wherein determining the first duration of the inactive timing period comprises:
determining a configured duration of the inactive timing period;
determining, based on the identification, an update coefficient for the inactive timing period; and
determining the first duration based on the configured duration and the update coefficient.

11. The method of claim 10, further comprising:
sending, to the terminal device, the update coefficient for the inactive timing period in response to the reception of the identification.

12. The method of claim 10, further comprising:
sending the first duration to the terminal device in response to the reception of the identification.

13. The method of claim 10, wherein the identification further indicates a data amount range of the data packet, and the update coefficient is determined based on the data amount range of the data packet.

14. The method of claim 10, wherein the update coefficient is determined based on a slot interval between at least two data transmissions between the network device and the terminal device.

15. The method of claim 14, wherein the slot interval comprises at least one of the following:
a first slot interval between the terminal device receiving data from the network device and the terminal device sending first acknowledgment information for the received data to the network device,
a second slot interval between the terminal device receiving control information scheduling the data packet from the network device and the terminal device sending the data packet to the network device, or
a third slot interval between the terminal device receiving second acknowledgment information for sent data from the network device and the terminal device retransmitting the data to the network device.

16. The method of claim 10, further comprising:
receiving data amount information from the terminal device, the data amount information indicating a data amount of the data packet to be sent;
determining resources allocated for the sending of the data packet; and
sending resource allocation information to the terminal device, the resource allocation information indicating the resources allocated for the sending of the data packet;
and wherein the update coefficient is determined based on the data amount of the data packet and an amount of the resources.

17. An electronic device, comprising:
at least one processor; and
at least one memory, the at least one memory being coupled to the at least one processor and storing instructions for execution by the at least one processor, the instructions, when executed by the at least one processor, causing the electronic device to perform operations comprising:
sending, to a network device, a scheduling request for a data packet to be sent, the scheduling request comprising an identification of the data packet, the identification representing a data packet with a data amount less than a threshold;
determining, based on the sending of the identification, a first duration of an inactive timing period for discontinuous reception of the terminal device; and
performing data transmission with the network device based on the first duration of the inactive timing period.

18. The electronic device of claim 17, wherein determining the first duration of the inactive timing period comprises:
receiving, from the network device, configuration information for the discontinuous reception, the configuration information indicating a configured duration of the inactive timing period;
determining, based on the identification, an update coefficient for the inactive timing period; and
determining the first duration based on the configured duration and the update coefficient.

19. The electronic device of claim 17, wherein determining the first duration of the inactive timing period comprises:
receiving, from the network device, indication information about the first duration in response to the sending of the identification, the first duration being determined by the network device based on a configured duration of the inactive timing period and an update coefficient for the inactive timing period.

20. The electronic device of claim 17, wherein determining the first duration of the inactive timing period comprises:
receiving, from the network device, configuration information for the discontinuous reception, the configuration information indicating a configured duration of the inactive timing period;
receiving, from the network device, indication information about an update coefficient in response to the sending of the identification, the update coefficient being configured to update a duration of the inactive timing period; and
determining the first duration based on the configured duration and the update coefficient.
